(19) United States
(12) Patent Application Publication
(10) Pub. No.: US 2005/0176383 A1
(43) Pub. Date: Aug. 11, 2005

(54) Re-configurable multiplexer, method for making it and branching unit for terrestrial radio links

(75) Inventors: Giuseppe Cereda, Ronco Briantino (IT); Antonio Morini, Ancona (IT)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/624,511

(22) Filed: Jul. 23, 2003

(30) Foreign Application Priority Data
Jul. 24, 2002 (EP) 02 291 858.5

(51) Int. Cl. H04B 1/46

(52) U.S. Cl. 455/82; 455/80

(57) ABSTRACT

Disclosed is a multiplexer that can be easily reconfigured, in the sense that the number of channels can be reduced or expanded by replacing the filters with suitable reactive loads and vice-versa. Although such loads are easy to manufacture, they are designed in such a way that the electrical characteristics of the remaining reconfigurable multiplexer maintains unaltered and additional tuning is not required. The present solution allows reducing both costs and losses of the branch by eliminating the circulators, although maintaining part of their flexibility.

The present invention generally relates to the field of radio transmissions and in particular relates to branching units. More in particular, it relates to a multiplexer which is re-configurable, to a method for making it and to a branching unit using such a re-configurable multiplexer.

As it is known, a wireless (or radio) transmission system comprises at least two transceivers placed at a distance one from each other. Electromagnetic energy emanates from an antenna of one of the radio transceivers and is received at the receiving side of the other transceiver. At the receiving side, the electromagnetic energy emanated from the transmitting antenna is passed through an antenna circulator and a proper branching unit up to the receiving modules. Analogously, at the transmission side, the electromagnetic energy is generated by proper transmission modules and passed through a branching unit and an antenna circulator up to the transmission antenna emanating the electromagnetic energy through the air. Sometimes, a branching unit is referred to as including also the antenna circulator. For the purpose of this patent application, a branching unit does not include an antenna circulator. Obviously, this convention choice does not affect the scope of the patent.

A first known type of branching unit for the use in connection with radio apparatus is a “circulator branching unit”. A circulator branching unit comprises a number of transmitting/receiving circulators and a corresponding number of transmitting/receiving filters, with the filters being coupled to the circulators and channelizing the energy therefrom into a corresponding number of channels that are isolated by means of corresponding isolators. Circulators operate in such a way that the signals entering the filters will be sent to a single output. The filters have the main object of keeping the signals at high levels and of avoiding that interference and noise affect the signals themselves.

Sometimes a branching unit is originally provided in a radio transceiver with a certain first number of transmitting/receiving circulators and a corresponding number of filters, the first number being lower than the maximum possible, and then is upgraded by increasing the number of circulators and filters. For instance, a fully equipped new generation radio apparatus can have ten (or more) transceivers but it could be firstly provided with only one or two (for a “1+0” or “1+1” configuration) of them. This choice could be for practical (low traffic to transport) and economical reasons as filters are rather expensive components.

Circulator branching units have the main advantages of being low cost and highly modular devices, namely it is possible to add filters and circulators as building blocks. The filters and circulators that were assembled in the first arrangement (sub-equipped) will continue to operate without making any tuning, nor test nor modification. Thus, modularity is a very attractive feature because, as said before, a sub-equipped circulator branching unit results in a less expensive component having the possibility to be upgraded by assembling further filters and circulators.

The main disadvantage of a circulator branching unit is that when a signal travels therethrough it undergoes rather high attentions and provides undesirable high insertion losses.

A possible alternative to a circulator branching unit is the so-called multiplexer branching unit. A known multiplexer branching unit comprises a transmitting/receiving main block, termed “manifold”, and a number of filters connected thereto. Typically, the filters are made by metal blocks provided with a number of reflective loads.

The main advantage of a multiplexer branching unit with respect to a circulator branching unit is that, fundamentally, insertion losses are negligible, more or less the same of a single channel filter. Furthermore, circulators are rather expensive, particularly below the X band.

The main disadvantage of a multiplexer branching unit lies in that its ability to convey the signal is provided only when the unit is in a “static” configuration. In other words, if the unit configuration is changed (typically one or more filters are added for one or more additional channels), the restoration of the performance requires a new tuning, resulting in a time consuming procedure that can not be tolerated, especially when the radio link is in operation. As said above, a branching unit is originally provided in a radio transceiver with a certain reduced number of filters and later on is upgraded by increasing the number of circulators and filters (for instance, due to the need to transport more traffic through the radio link or to provide a more robust configuration against failures). Thus, it is not practically possible to upgrade a multiplexer branching unit. Just for these reasons, multiplexer branching units are generally referred to as “non reciprocal multiplexers”. In view of their characteristics, non-reciprocal multiplexers are generally used for satellite communications (where costs problems are reduced and there is neither need nor possibility to upgrade) and military applications.

A possible solution to this problem could be providing a large number of different multiplexer branching units, with each unit being different from another unit due to the number of filters. Unless to say that this is not practical.

A further possible solution approach could be providing all the multiplexer branching units with the same (maximum) number of filters, namely providing the multiplexer branching units in a fully equipped configuration. This is clearly disadvantageous because the sub-equipped unit becomes very expensive, as expensive as the fully equipped one.

Thus, briefly, a circulator branching unit is desirable in view of its modularity characteristics but is unprofitable for the high attenuation and the undesirable high insertion losses; the multiplexer branching unit is not modular but provides low attenuations and low insertion losses.

In view of the above disclosed prior-art arrangements, the main object of the present invention is providing a branching unit offering modularity characteristics as well as low attenuations and low insertion losses. In other words, the main object of the present invention is providing a branching unit whose number of channels could be varied without altering the response of the remaining ones, thus providing what we will call a “re-configurable multiplexer” (r-mux) branching unit.

This and further objects are obtained by a re-configurable multiplexer having the features set forth in the independent claim 1, and a branching unit employing such a re-configurable multiplexer according to claim 11 and a method for making such a multiplexer according to claim 6. Further advantageous characteristics are indicated in the respective dependent claims. All the claims form an integral part of the present description.

The basic idea of the present invention is to provide a reciprocal, or re-configurable (r-mux), multiplexer that can be easily reconfigured, in the sense that the number of channels can be reduced or expanded by replacing the filters by suitable reactive loads and vice-versa. Although easy to manufacture, such loads are designed in such a way that the electrical characteristics of the remaining r-mux maintain unaltered and additional tuning is not required. The proposed solution allows reducing both costs and losses of the branch by eliminating the circulators, although maintaining their advantageous flexibility.

In other words, filters are replaced by components virtualizing the filter behavior. Advantageously, the components virtualizing the filter behavior are low cost components. Should the need of upgrading the branching unit arise, the low cost component will be taken away and a corresponding real filter installed without performing any further tuning operation.

The invention will become clear after reading the following detailed description, given merely as an example and not for limitation, to be read with reference to the attached figures wherein:

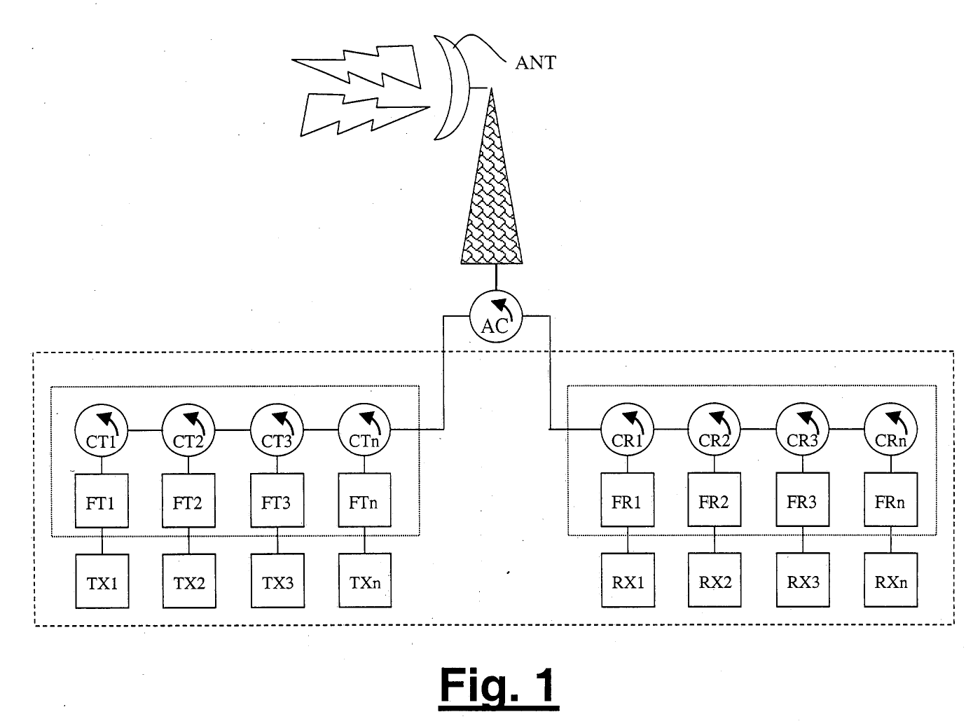

FIG. 1 shows schematically a classical arrangement for civil radio link multiplexing made by circulators and filters;

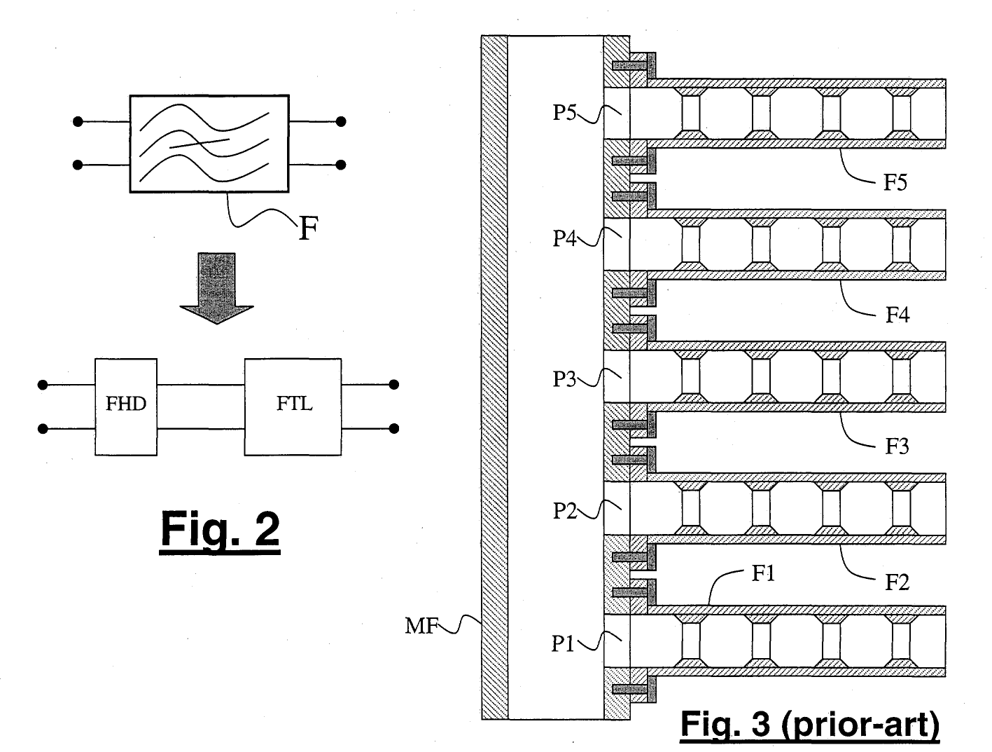

FIG. 2 shows schematically a filter that is splitted into a header and a tail, the header being mostly responsible for the phase response in the out band;

FIG. 3 is a schematic planar sectional view of a multiplexer according to the prior-art;

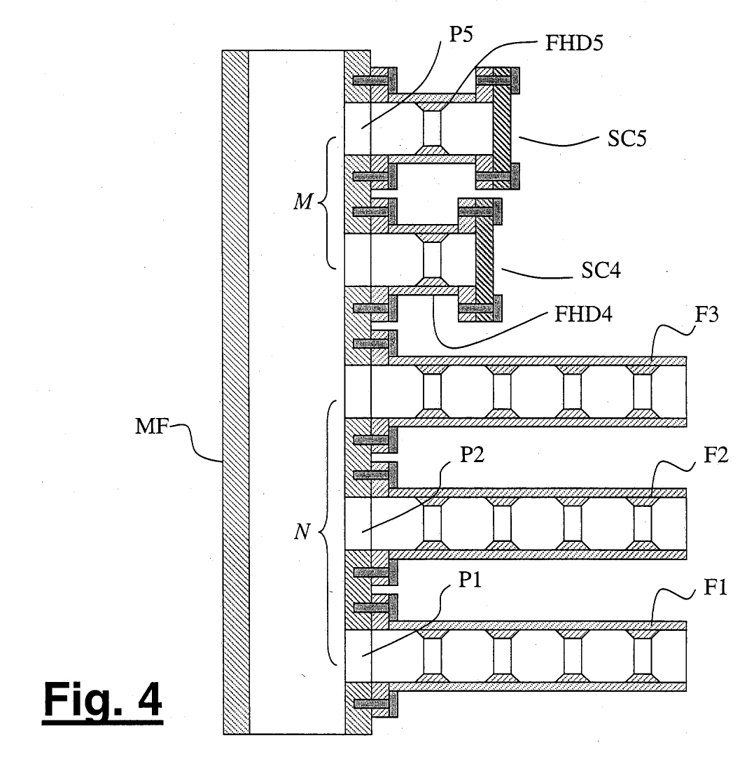

FIG. 4 is a schematic planar sectional view of a first embodiment of the reconfigurable multiplexer according to the present invention with three filters and two filter heads with corresponding shorts;

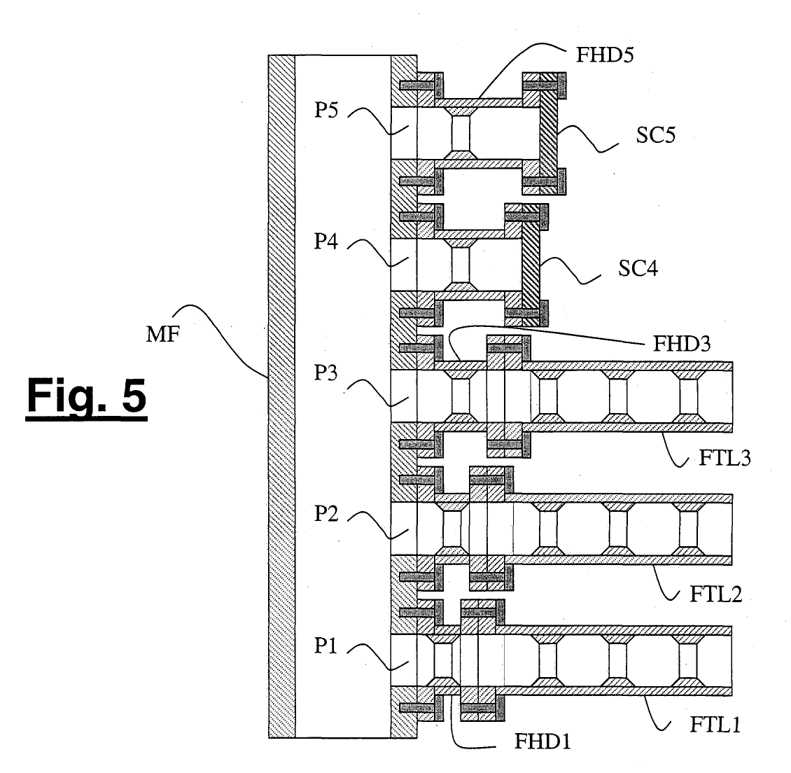

FIG. 5 is a schematic planar sectional view of the first embodiment of the reconfigurable multiplexer according to the present invention with five filter heads, three filter tails and two shorts;

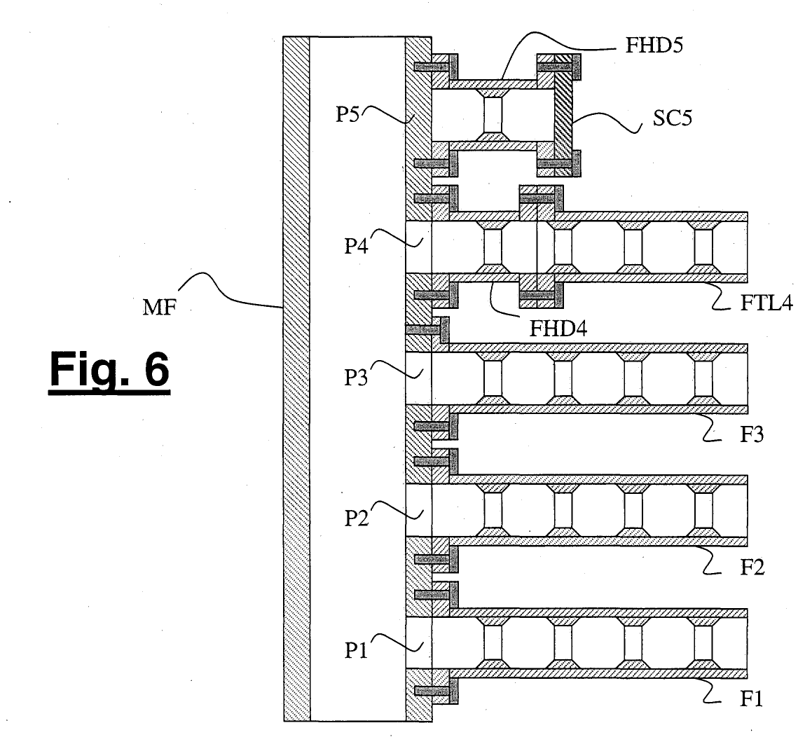

FIG. 6 is a schematic planar sectional view of the first embodiment of the reconfigurable multiplexer according to the present invention with three filters, two filter heads one filter tail and one short;

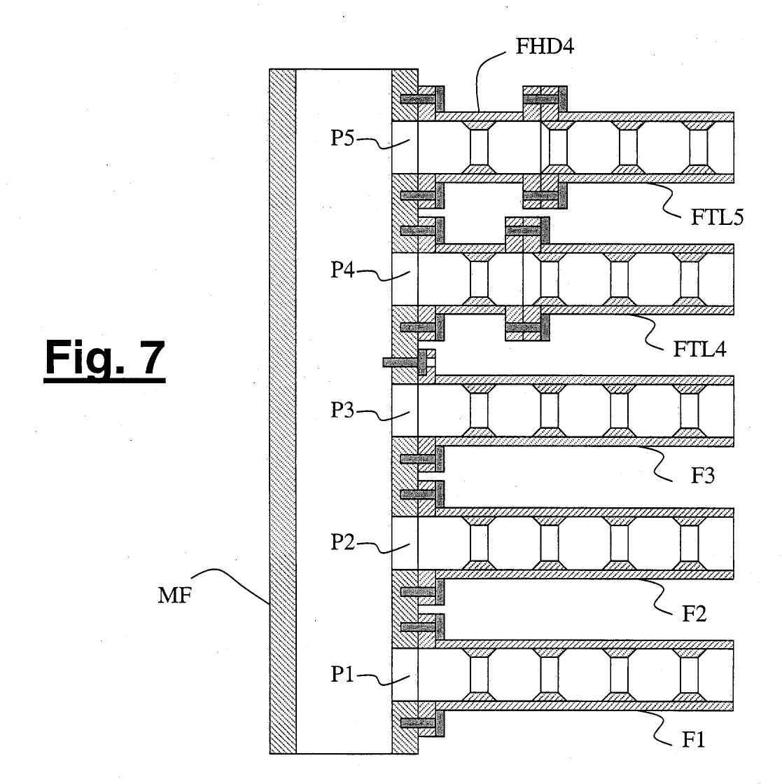

FIG. 7 is a schematic planar sectional view of the first embodiment of the reconfigurable multiplexer according to the present invention with three filters, two filter heads and two filter tails;

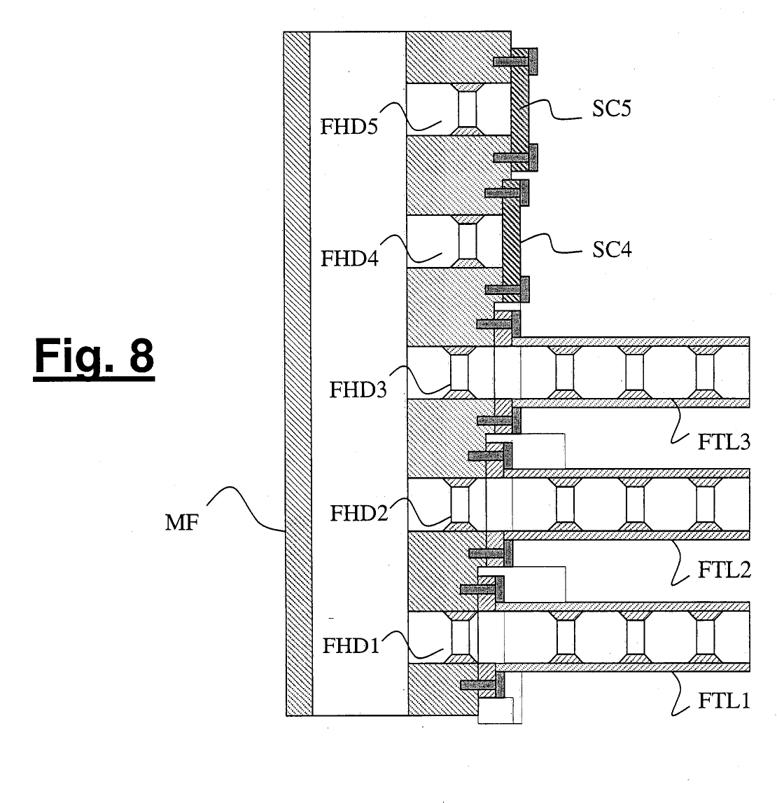

FIG. 8 is a schematic planar sectional view of the second embodiment of the reconfigurable multiplexer according to the present invention with three filter tails and two shorts;

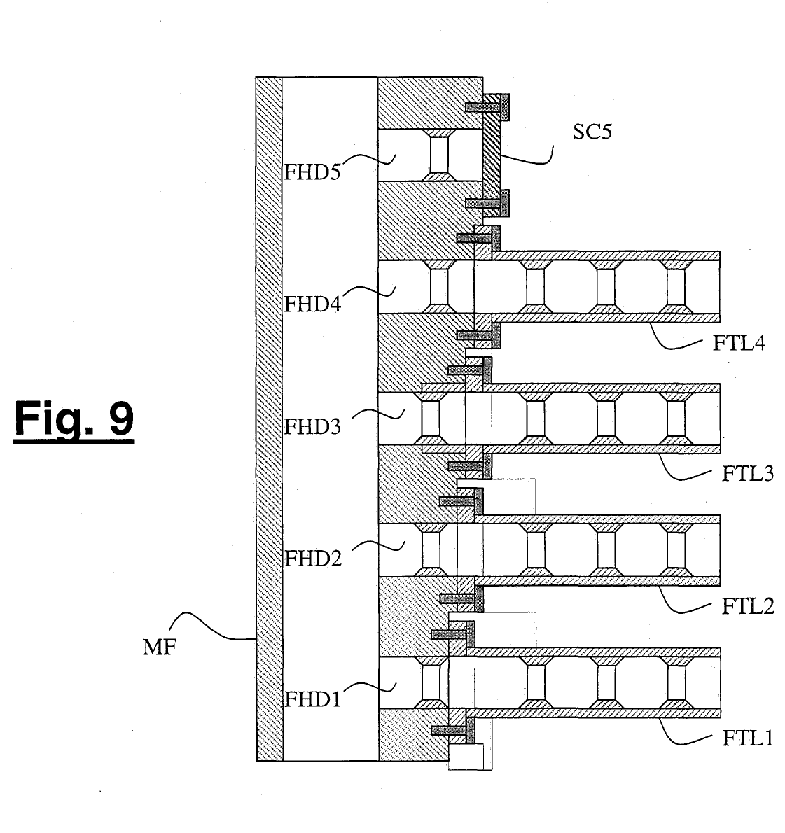

FIG. 9 is a schematic planar sectional view of the second embodiment of the reconfigurable multiplexer according to the present invention with four filter tails and one short; and

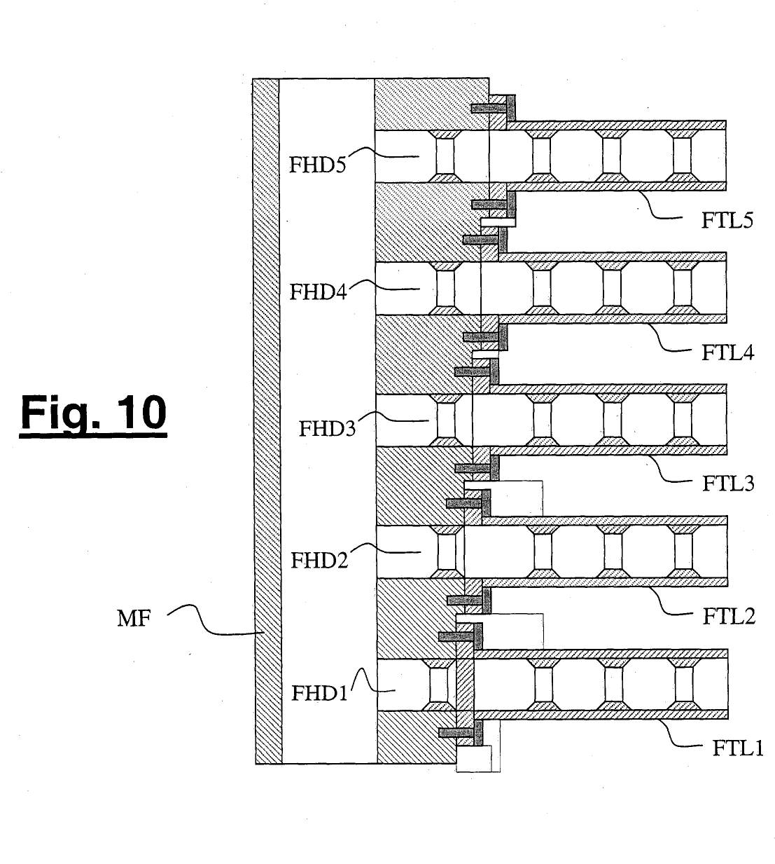

FIG. 10 is a schematic planar sectional view of the second embodiment of the reconfigurable multiplexer according to the present invention with five filter tails.

FIG. 1 shows a classical arrangement for civil radio link multiplexing comprising circulators and filters. In detail, the arrangement comprises: a number (four in the example) of transmission modules TX1, TX2, TX3, TXn; a corresponding number of filters FT1, FT2, FT3, FTn; a corresponding number of circulators CT1, CT2, CT3, CTn; a number (four in the example) of reception modules RX1, RX2, RX3, RXn; a corresponding number of filters FR1, FR2, FR3, FRn; a corresponding number of circulators CR1, CR2, CR3, CRn; an antenna circulator AC; and an antenna ANT, possibly connected to a proper basement in a raised position. The assembly of filters, circulators, transmission and reception modules and, possibly, the antenna circulators forms a branching unit BRU.

The signal generated by the first transmission module TX1 is passed to the corresponding transmission filter FT1, sent to the proper circulator CT1 and sent to the antenna circulator AC. From the antenna circulator AC, the signal is passed to the antenna ANT for sending through the air. When a signal is received from the antenna ANT, it is first passed through the antenna circulator AC. Then it is sent to the proper reception circulator, for instance CR1, to the corresponding filter FR1 and finally to the reception module RX1.

According to the present invention, the filter and circulator arrangement (clearly shown by a rectangular doffed box) of FIG. 1 is replaced by a re-configurable multiplexer. FIG. 2 shows in a very schematic manner, a filter that is splitted into a filter header and a filter tail, the header being mostly responsible for the phase response in the out band. The filter header (or head) FHD fundamentally comprises at least the first cavity while the filter tail FTL comprises the remaining cavities.

It has been observed that the phase-behavior of a channel in its out band is mainly due to the first elements of the corresponding filters. This means that the behavior of a filter in its out band can be accurately approximated by a load obtained by shortening the first part of the filter.

FIG. 3 shows a schematic planar sectional view of a multiplexer according to the prior-art. The multiplexer comprises a manifold MF and a number (five in the example) of filters F1, F2, . . . F5. Each filter F in turn comprises a metal body and a number of reflective loads, typically reflective cavities. The filters are connected to the manifold through a proper arrangement (for instance, bolts). Each filter F1, F2, . . . F5 communicates with the manifold MF through a corresponding port P1, P2, . . . , P5. As said above, in case one wants to have a subequipped multiplexer (namely a multiplexer with a reduced number of filters), a properly reduced multiplexer should be provided or expensive (and not used) filters should be assembled on the manifold (as in FIG. 3).

According to the present invention, a manifold is provided with a number N+M of ports. In a subequipped configuration only N filters should be used and thus only N ports are connected to corresponding N filters. The basic idea is to design M reflective loads, that can replace the corresponding M filters of the original N+M port mux. Such loads accomplish the following goals: the reduced N-port multiplexer does not require additional tuning to operate correctly and furthermore the reflective loads are low cost. It is therefore crucial that each load has the same behavior of the filter to be replaced, at least in the regions closer to the pass-band, where the interaction is stronger.

A load with the above-mentioned characteristics is easily obtained by terminating the corresponding filter on a short circuit. Of course, the response of the multiplexer does not change, except of the in-band of the shorted filter. However this solution is too expensive as the supplier should provide a mux fully equipped of all filters, even when the customer requires only a few. On the other hand, it is noted that the phase response of a filter in its out-band is mainly due to the first cavities.

The load is therefore formed by the first coupling, the first cavity, the second coupling and a short circuit placed in such a way as to minimize the deviation between the phase response of the original filter and the one of the shorted head.

FIG. 4 is a schematic planar sectional view of a first embodiment of the reconfigurable multiplexer according to the present invention. The first embodiment comprises a manifold MF with a number (five in the example) of ports for communicating with filter arrangements. Indeed, ports P1, P2, P3 communicate with standard filters F1, F2, F3. The remaining ports P4, P5 are connected with filter heads FHD4, FHD5. According to the present invention, the filter heads comprise at least the first resonant cavity of each filter. Furthermore, the filter heads FHD4, FHD5 are connected to corresponding plates SC4, SC5 acting as short circuits.

In general terms, we could say that the manifold of FIG. 4 has N+M ports. N ports (P1, P2, P3 in the example) communicate with N corresponding filters (F1, F2, F3) while M ports (P4, P5) are not connected to any complete filters but to filter heads (FHD4, FHD5). This could be a typical situation where a radio transceiver is sub-equipped in order to provide communication only through a number N of channels of the N+M channels that are in principle available. It is desirable to have the possibility to increase the number of channels up to N+M without performing a further tuning.

As it is clear from FIG. 4, the shorts SC4, SC5 are at a certain distance from the manifold which is calculated as below explained.

FIG. 5 is similar to FIG. 4. The difference being in that the three filters F1, F2, F3 are replaced by three filter head and tail arrangements FHD1, FTL1; FHD2, FTL2; FHD3, FTL3 providing the very same functionality of the filters.

FIG. 6 shows the reconfigurable multiplexer according to the first embodiment of the present invention in an intermediate subequipped stage. The purpose of this figure is to show that short circuit SC4 has been replaced by a filter tail in order to provide the functionality of a further filter by the FHD4+FTL4 arrangement. Thus, advantageously, the reconfigurable multiplexer so arranged has been improved without having to perform further tuning.

FIG. 7 shows the reconfigurable multiplexer according to the first embodiment of the present invention in a fully equipped configuration. Again, the reconfigurable multiplexer so arranged has been further improved without having to perform any further tuning.

It is easily realized that the assembly of filter head and short circuit is considerably less expensive than a complete filter. In case the need arises to provide additional channels, we have two options. The first option (illustrated in the various figures) comprises taking the cover away and mounting the corresponding filter tail (comprising the rest of cavities and couplings) to the filter head. The second option (not illustrated) comprises taking both the filter head and cover away and mounting a complete filter. The second option is clearly less desirable as the filter head is wasted. In any case, no additional tuning is requested as the filter head and short circuit cover virtualize a full filter.

FIGS. 8-10 show the second embodiment of the reconfigurable multiplexer according to the present invention. The main difference with respect to the first embodiment is that the filter heads are integrated in the manifold. Again, the filter heads comprise at least the corresponding first cavity of each filter.

The multiplexer of FIG. 8 is functionally similar to the one of FIGS. 4-5: Three filter tails FTL1, FTL2, FTL3 are mounted to the manifold in order to provide three filter head and tail units FHD1, FTL1; FHD2, FTL2; and FHD3, FTL3. The remaining filter heads FHD4, FHD5 are connected to shorts SC4, SC5 in the form of closure plates. In case there is the need to provide a further filter, one of the closure plates (SC4, see FIG. 9) is removed and replaced by a proper filter tail FTL4. In order to obtain a fully equipped multiplexer, also the remaining closure plate SC5 is removed and a filter tail FTL 5 is mounted as it is clear in FIG. 10. It should be clear that passing from the arrangement of FIG. 8, through the one of FIG. 9, to the one of FIG. 10, advantageously no additional tuning is required.

In any case, any short should be shifted by a distance lₖ. Once the reflection s₁₁(fᵤ₍ₖ₋₁₎lₖ) of the k-th tail has been calculated at the upper limit fᵤ₍ₖ₋₁₎ of the pass-band of the (k−1)-th channel, the shift distance lₖ from the k-th head at which the short circuit must be positioned to correctly replace the corresponding tail is given by formula 1 below:

$${l}_{k} = \frac{1}{- 2 j β ( {f}_{{u}_{( k - 1 )}} )} ln ( - {s}_{11} ( {f}_{{u}_{( k - 1 )}} ) ) \qquad ( 1 )$$

Where lₖ is the position/distance of short circuit replacing the k-th tail; fᵤ_{₍ₖ₋₁₎} is the maximum frequency of (k-1)-th channel; S₁₁(fᵤ_{₍ₖ₋₁₎}) is the reflection coefficient of the tails of k-th channel that is calculated at the frequency fᵤ_{₍ₖ₋₁₎};

$$β ( {f}_{{u}_{( k - 1 )}} ) = \sqrt{{k}_{0}^{2} - {( \frac{π}{a} )}^{2}}$$

where k₀=2πfᵤ_{₍ₖ₋₁₎}×\sqrt{μ₀ε₀}.

Note that |s₁₁(fᵤ_{₍ₖ₋₁₎})|=1, as the k-th filter is in its out-band. Alternatively, one could choose lₖ by imposing the equivalence between the tail and the shifted short at the lower frequency of the passband of the k+1 filter. Both choices are possible and one has to take the more convenient one. In any case, the results obtained by removing one, two, three, . . . n filters and closing the headers of the multiplexer channels on the shorts shifted as indicated above are very good.

Each channel works correctly when the corresponding tail is properly connected to the modified manifold. On the other hand, a channel is disabled when the tail is removed and the corresponding head is shorted. Nevertheless, the reduced channel multiplexer operates finely, because the load formed by the head terminated on the short circuit has the same behavior as the original filter, in the out-band.

In conclusion, starting from a N+M channel mux, the replacement of M filter tails with shorts one reduces the multiplexer order without altering the responses of the remaining N channels and, conversely, the substitution of M shorts with the corresponding tails, increase the number of the multiplexer channels (from N to N+M), not affecting the characteristics.

As far as the realization of the modified manifold (the one integrating the filter heads) is concerned, it is convenient to use standard waveguide technology, for instance H-plane. The tails can be obtained either by the same technology as the heads or by different solutions, as for example by DR technology to make the device more compact.

In practice, tails and shifted shorts can be interchanged without altering the in-band response of the remaining r-mux. The results that have been obtained suggest that the re-multiplexer can be tuned separately, namely considering the manifold (containing the filter headers or with the filter headers connected thereto) and the filter tails. The manifold is tuned when connected to a set of tails, assumed as reference, and the filter tails are tuned when connected to a reference manifold. By the way, the tails perfectly match on manifolds previously tuned and this results in a very advantageous feature.

1. Reconfigurable multiplexer for wireless transceivers comprising a manifold (MF) and filter means to be connected to the manifold (MF) at proper locations (P1, P2, . . . P5), characterized in that at least one of said filter means comprises a filter head (FHD1, FHD2, . . . FHD5) connectable either to a corresponding covering plate (SC1, SC2, . . . SC5) for short circuit purposes or to a filter tail (FTL1, FTL2, . . . FTL5) in order to provide full filter functionality.

2. Reconfigurable multiplexer according to claim 1, characterized in that the at least one filter head (FHD1, FHD2, . . . FHD5) comprises at least a first coupling and a first cavity.

3. Reconfigurable multiplexer according to claim 2, characterized in that the at least one filter head (FHD1, FHD2, . . . FHD5) further comprises a second coupling.

4. Reconfigurable multiplexer according to claim 1, characterized in that the at least one filter head (FHD1, FHD2, . . . FHD5) is an integral part of the manifold (MF).

5. Reconfigurable multiplexer according to claim 1, characterized in that the covering plate (SC1, SC2, . . . SC5) is at a distance with respect to the manifold axis.

6. A method for providing a reconfigurable multiplexer for wireless transceivers comprising:
providing a manifold (MF); and
providing filter means to be connected to the manifold (MF) at proper locations (P1, P2, . . . P5),
characterized in that the step of providing filter means comprises providing at least one filter head (FHD1, FHD2, . . . FHD5) connectable either to a corresponding covering plate (SC1, SC2, . . . SC5) for short circuit purposes or to a filter tail (FTL1, FTL2, . . . FTL5) in order to provide full filter functionality.

7. Method according to claim 6, characterized in that the step of providing at least one filter head (FHD1, FHD2, . . . FHD5) comprises the step of providing at least one filter head comprising at least a first coupling and a first cavity.

8. Method according to claim 7, characterized in that the step of providing at least one filter head (FHD1, FHD2, . . . FHD5) further comprises the step of providing at least one filter head comprising a second coupling.

9. Method according to claim 6, characterized in that the step of providing the at least one filter head (FHD1, FHD2, . . . FHD5) comprises the step of forming such at least one filter head as an integral part of the manifold (MF).

10. Method according to claim 9, characterized in that the at least one filter head is made through standard waveguide technology, preferably H-plane and the corresponding at least one filter tail is made either by H-plane technology or by DR technology to make the device more compact.

11. Branching unit comprising one or more reconfigurable multiplexers according to claim 1.
